(19) United States
(12) Patent Application Publication
(10) Pub. No.: US 2018/0357300 A1
(43) Pub. Date: Dec. 13, 2018

(54) PUBLISH / SUBSCRIBE ENGINE BASED ON CONFIGURABLE CRITERIA

(71) Applicant: Element Data, Inc., Seattle, WA (US)

(72) Inventors: Viswanath Vadlamani, Sammamish, WA (US); Phani Vaddadi, Bellevue, WA (US); Charles F. L. Davis, III, Elk Grove, CA (US)

(21) Appl. No.: 15/836,653

(22) Filed: Dec. 8, 2017

Related U.S. Application Data
(60) Provisional application No. 62/516,810, filed on Jun. 8, 2017.

(51) Int. Cl. G06F 17/30; G06N 5/02

(52) U.S. Cl. CPC G06F 17/30601; G06N 5/02; G06F 17/30011

(57) ABSTRACT

Example methods, apparatuses, and systems (e.g., machines) are presented for a natural language classification engine or platform capable of processing configurable classification criteria in real time or near real time. While typical classification engines tend to require specific training for each domain to be classified for a subscriber, the classification engine of the present disclosure is capable of analyzing a single corpus of human communications and providing only the relevant messages or documents according to criteria generated on the fly by a subscriber. The classification engine of the present disclosure need not know beforehand what type of content is desired by the subscriber. In this way, the criteria specified by a subscriber can change dynamically, and the classification engine of the present disclosure may be capable of evaluating the criteria and then provide relevant documents or messages according to the changed criteria, without needing additional corpus training.

### CROSS REFERENCES TO RELATED APPLICATIONS

This application claims the benefit of U.S. Provisional Application 62/516,810, filed Jun. 8, 2017, and titled “PUBLISH/SUBSCRIBE BASED ON CONFIGURABLE CRITERIA,” the disclosure of which is hereby incorporated herein in its entirety and for all purposes.

### TECHNICAL FIELD

The subject matter disclosed herein generally relates to processing data. In some example embodiments, the present disclosures relate to a publish/subscribe classification engine based on configurable criteria.

### BACKGROUND

The advance of technology to ingest and classify the millions of digital human communications should provide new functionality and improved speed. Typical classification engines used to classify subsets of the never-ending stream of digital human communications tend to require weeks of prior corpus training, and may be too slow to dynamically adapt to the ever changing trends in social media and news in general. It is desirable to generate improved classification techniques to be more flexible and dynamic in the face of an ever-changing environment.

### BRIEF SUMMARY

Aspects of the present disclosure are presented for a classification engine or platform capable of processing configurable classification criteria in real time or near real time.

In some embodiments, a method of a classification engine for classifying a stream of human communications in real time is presented. The method may include: accessing, by the classification engine, a classification criteria expression specified by a subscriber of the classification engine, the classification criteria expression comprising a description of one or more topics for the classification engine to search for and classify among the stream of human communications; evaluating, using artificial intelligence techniques by the classification engine, the classification criteria expression to determine a number of topics specified in the classification criteria expression to be classified in the stream of human communications; evaluating, using artificial intelligence techniques by the classification engine, the classification criteria expression to associate each of the topics to a predetermined classification criterion that is stored in a memory and generated by a training phase performed by the classification engine, wherein each of the topics as expressed in the classification criteria expression do not exactly match wording in the predetermined classification criterion to which each of the topics are associated to; accessing, by the classification engine, the stream of human communications in real time; conducting, by the classification engine, a classification function to identify documents in the stream of human communications that are relevant to at least one of each of the predetermined classification criteria associated to each of the topics in the classification criteria expression; and displaying, by the classification engine, the relevant documents out of the stream of human communications.

In some embodiments, the method further includes accessing, by the classification engine, an additional classification criteria expression specified by the subscriber while still accessing the stream of human communications in real time and conducting the classification function. In some embodiments, the method further includes evaluating the additional classification criteria expression to determine a number of topics in the additional classification criteria to be classified in the stream of human communications, while still accessing the stream of human communications in real time and conducting the classification function. In some embodiments, the method further includes evaluating the additional classification criteria expression to associate each of the additional topics to the predetermined classification criterion that is stored in the memory and generated by the training phase performed by the classification engine, wherein no additional training phase is performed in order to associate each of the additional topics to the predetermined classification criterion.

In some embodiments of the method, each of the predetermined classification criterion are stored in a configuration file that is generated by the training phase.

In some embodiments of the method, the classification criteria expression includes logical terms comprising at least one of an “AND” expression, “OR” expression, “NOR” expression, and “XOR” expression. In some embodiments of the method, the predetermined classification criterion does not include any of the logical terms “AND,” “OR,” “NOR” or “XOR.” This is one example of the classification criteria expression not including the same words contained in the predetermined classification criterion, and yet the classification engine is still capable of understanding the expression given by the subscriber.

In some embodiments, a classification system for classifying a stream of human communications in real time is presented. The system may include: a classification engine comprising at least one processor and at least one memory, the at least one processor configured to utilize artificial intelligence; a subscriber portal coupled to the classification engine and configured to interface with a subscriber of the classification system; and a display module communicatively coupled to the classification engine. The classification engine may be configured to: access a classification criteria expression specified by the subscriber, through the subscriber portal, the classification criteria expression comprising a description of one or more topics for the classification engine to search for and classify among the stream of human communications; evaluate, using artificial intelligence techniques by the classification engine, the classification criteria expression to determine a number of topics specified in the classification criteria expression to be classified in the stream of human communications; evaluate, using artificial intelligence techniques by the classification engine, the classification criteria expression to associate each of the topics to a predetermined classification criterion that is stored in the at least one memory and generated by a training phase performed by the classification engine, wherein each of the topics as expressed in the classification criteria expression do not exactly match wording in the predetermined classification criterion to which each of the topics are associated to; access the stream of human communications in real time; and conduct a classification function to identify documents in the stream of human communications that are relevant to at least one of each of the predetermined classification criteria associated to each of the topics in the classification criteria expression. The display module may be configured to display the relevant documents out of the stream of human communications.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2 shows an example functional block diagram of a classification engine or platform of the present disclosure, according to some embodiments.

FIG. 3 shows an example subscription configuration file that may be accessed by the classification engine, according to some embodiments.

FIG. 4 provides an example methodology of a classification engine of the present disclosure for processing classification queries in real time or near real time, as well as processing new classification queries while live streaming human communications, and providing the results to a subscriber, according to some embodiments.

FIG. 5 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented for a natural language classification engine or platform capable of processing configurable classification criteria in real time or near real time. While typical classification engines tend to require specific training for each domain to be classified for a subscriber, the classification engine of the present disclosure is capable of analyzing a single corpus of human communications and providing only the relevant messages or documents according to criteria generated on the fly by a subscriber. The classification engine of the present disclosure need not know beforehand what type of content is desired by the subscriber. In this way, the criteria specified by a subscriber can change dynamically, and the classification engine of the present disclosure may be capable of evaluating the criteria and then provide relevant documents or messages according to the changed criteria, without needing additional corpus training.

In some embodiments, a subscriber may enter criteria for a first domain expressed in a wide range of possibilities. For example, the subscriber may use keywords, natural words, specify a particular example, and/or specify a particular time frame, and may express these in various ways that the subscriber is comfortable with. The classification engine of the present disclosure may be configured to evaluate this criteria string using natural language processing, machine learning and other artificial intelligence means. Later, the subscriber may change the criteria to have the classification engine provide results for a second domain using the same body of documents and messages. For example, the classification engine may be configured to continually classify messages from Twitter®, and may provide to a subscriber all relevant messages about Halloween. Later, the subscriber may change the criteria to have the classification engine provide all relevant messages about Thanksgiving, using the same streaming body of messages on Twitter®. No additional training by the classification engine may be needed. The classification engine of the present disclosure allows for a high degree of flexibility in much less time.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

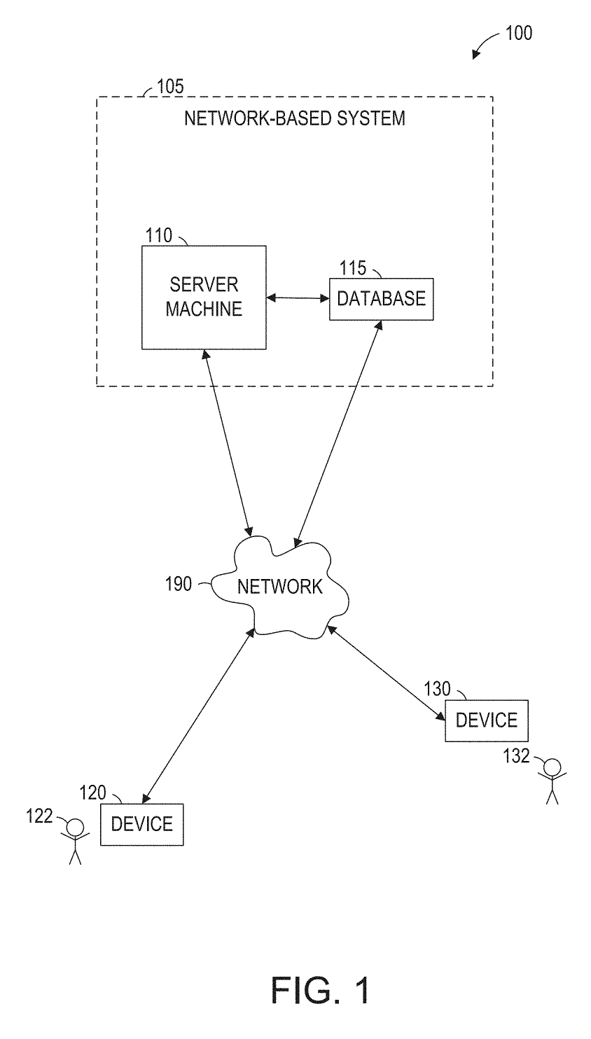

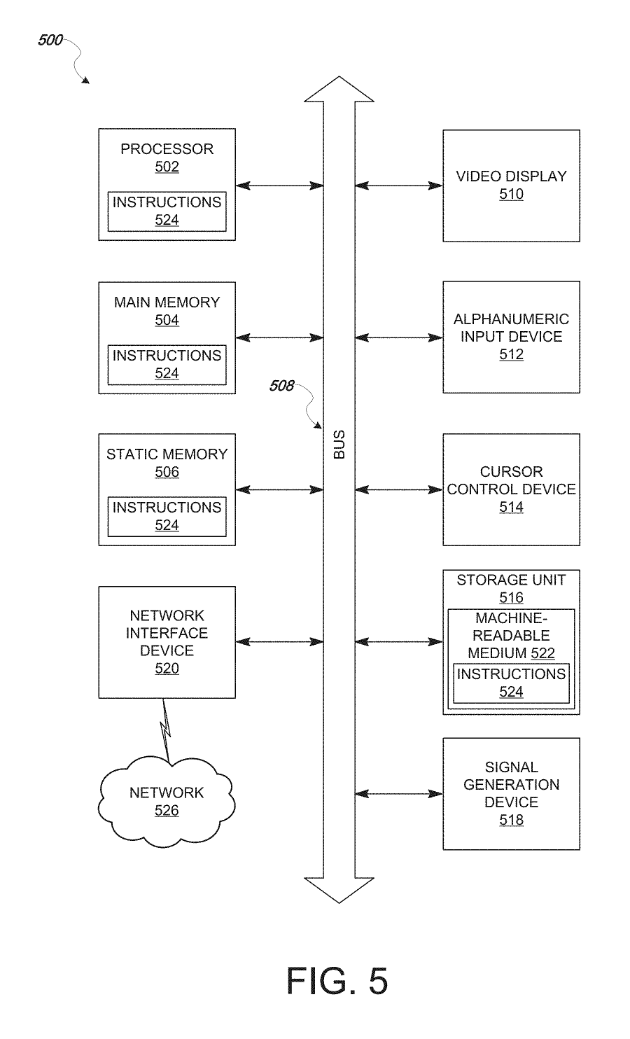

Referring to FIG. 1, a network diagram illustrating an example network environment 100 suitable for performing aspects of the present disclosure is shown, according to some example embodiments. The example network environment 100 includes a server machine 110, a database 115, a first device 120 for a first user 122, and a second device 130 for a second user 132, all communicatively coupled to each other via a network 190. The server machine 110 may form all or part of a network-based system 105 (e.g., a cloud-based server system configured to provide one or more services to the first and second devices 120 and 130). The server machine 110, the first device 120, and the second device 130 may each be implemented in a computer system, in whole or in part, as described below with respect to FIG. 5. The network-based system 105 may be an example of a classification platform or engine according to the descriptions herein. The server machine 110 and the database 115 may be components of the auction engine configured to perform these functions. While the server machine 110 is represented as just a single machine and the database 115 where is represented as just a single database, in some embodiments, multiple server machines and multiple databases communicatively coupled in parallel or in serial may be utilized, and embodiments are not so limited.

Also shown in FIG. 1 are a first user 122 and a second user 132. One or both of the first and second users 122 and 132 may be a human user, a machine user (e.g., a computer configured by a software program to interact with the first device 120), or any suitable combination thereof (e.g., a human assisted by a machine or a machine supervised by a human). The first user 122 may be associated with the first device 120 and may be a user of the first device 120. For example, the first device 120 may be a desktop computer, a vehicle computer, a tablet computer, a navigational device, a portable media device, a smartphone, or a wearable device (e.g., a smart watch or smart glasses) belonging to the first user 122. Likewise, the second user 132 may be associated with the second device 130. As an example, the second device 130 may be a desktop computer, a vehicle computer, a tablet computer, a navigational device, a portable media device, a smartphone, or a wearable device (e.g., a smart watch or smart glasses) belonging to the second user 132. The first user 122 and a second user 132 may be examples of users, subscribers, or customers interfacing with the network-based system 105 to utilize the classification methods according to the present disclosure. The users 122 and 132 may interface with the network-based system 105 through the devices 120 and 130, respectively.

Any of the machines, databases 115, or first or second devices 120 or 130 shown in FIG. 1 may be implemented in a general-purpose computer modified (e.g., configured or programmed) by software (e.g., one or more software modules) to be a special-purpose computer to perform one or more of the functions described herein for that machine, database 115, or first or second device 120 or 130. For example, a computer system able to implement any one or more of the methodologies described herein is discussed below with respect to FIG. 5. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases 115, and devices (e.g., the server machine 110 and the first device 120). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

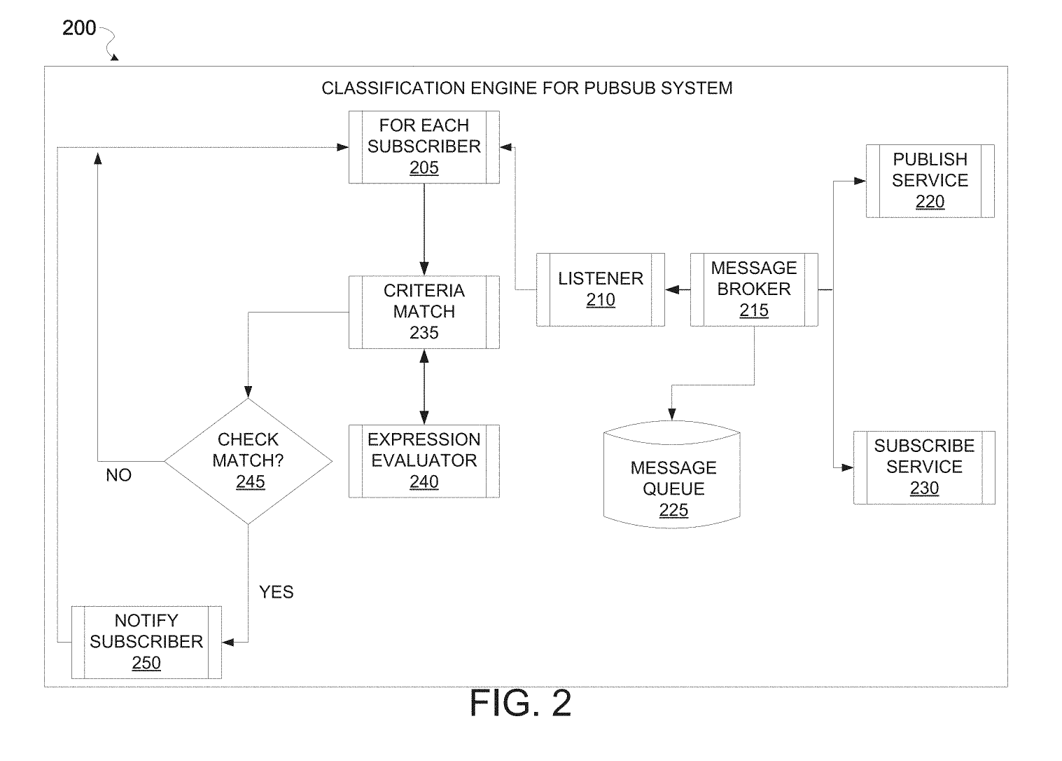

Referring to FIG. 2, illustration 200 shows an example functional block diagram of a classification engine or platform of the present disclosure, according to some embodiments. This block diagram includes functional elements for how the classification engine obtains classification criteria from a subscriber, evaluates the criteria, identifies relevant documents or messages from the stream of human communications, and then transmits those results to the subscriber. As previously mentioned, the criteria may change dynamically, while the classification engine continues to access the stream of human communications.

Starting a block 205, for each subscriber, a listener module 210 is configured to monitor any actions performed by the subscriber. The listener interacts with a message broker 215. When classification criteria are specified by the subscriber—which could occur at any time—the listener 210 picks up the communications and passes it onto the message broker 215, who begins the process of attempting to the connect the subscriber's criteria with various services for the subscriber.

The message broker 215 is configured to facilitate communication and interaction between the publishing service 220, the message queue 225, and the subscription service 230. The publishing service 220 enables a centralized publishing of classification results passing through the system. The subscriber can see their results based on their specified classification criteria, and in some cases other subscribers may also be designated to see these results, through the publishing service 220. The subscription service 230 can be configured to receive data. The subscription service 230 also provides various administrative services, such as providing billing and biographical information. The message queue 225 provides an orderly way for data between the publishing service 220, the message broker 215, and the subscription service 230 to be managed. In some embodiments, the message queue 225 is a FIFO queue that stores the messages and events as they arrive and is made available for processing.

The left side of the illustration 200 provides a functional block diagram for determining how to process a classification query by a subscriber. Starting again from block 205, for any subscriber, the classification engine may first access the specified classification criteria and may conduct, at block 235, a criteria match to determine how the criteria entered by the subscriber matches known criteria already processed by the classification engine. For example, the classification engine may have already developed a configuration file that contains a list of different criteria. The classification engine may compare the specified criteria by the subscriber to items in the configuration file. As the query made by the subscriber is not expected to exactly match the criteria in the configuration file, the specified criteria may be evaluated by an expression evaluator 240, such as an engine utilizing NLP, ML, and/or UHRS (Universal Human Relevance System) programming. The expression evaluator 245 extracts the specified classification criteria from a query entered by the subscriber and evaluates for its expression value.

The style, nature, and word usage of the query can vary in numerous ways. For example, the subscriber may specify the classification engine to “provide all relevant tweets related to the climate change.” As another example, the query criteria may be “climate change.” As another example, the query criteria may be “global warming scientific literature.” As another example, the query criteria may be “climate change/global warming/unusual weather/changing ecology.” The search criteria can be even more complicated, including conditional or other logical expressions, such as “all tweets discussing climate change that have more than 100 likes.” In addition, and as alluded to in some of these examples, multiple topics can be specified at the same time. Vastly different topics can be specified as well, such as “climate change or Taylor Swift or graphene.” The classification engine may be configured to provide all communications among the streaming set that fit any of those topics. The classification engine does not simply rely on keywords, however. Using natural language processing, machine learning and UHRS techniques, the classification engine may be configured to associate the words in the criteria to certain categories already found in its configuration file, even if the exact words do not match, according to some embodiments. For example, the classification engine may be configured to perform fuzzy matching and process generalized string matching. This increases the flexibility for the subscriber and also provides for a high degree of granularity and specificity. These new functionalities may be a great improvement over typical classification platforms currently available to address a complex set of end user scenarios that depend on a diverse set of subscription criteria.

An example code implementation, according to some embodiments, for performing the expression evaluation is the following:

```
function meetsComplexCriteria(p_rec,p_cc)
  {
    returnValue = false;
    var rvLogical=[ ];
    if(!p_cc.hasOwnProperty(″arrCriteria″))
      return false;
    var opLogical = ″&&″;
    if(p_cc.hasOwnProperty(″op″))
      opLogical = p_cc.op;
    var arrCriteria = p_cc.arrCriteria;
    for(var i in arrCriteria)
    {
      var op = ″%″;
      if(arrCriteria[i].hasOwnProperty(″op″))
        op = arrCriteria[i].op;
      if(!arrCriteria[i].hasOwnProperty(″Criteria″))
      {
        logger.trace(″Complex criteria needs operator and criteria″);
        break;
      }
      var p_criteria = arrCriteria[i].Criteria;
      var rv = [ ];
      for (var key in p_criteria)
      {
        rv[key] = { };
        rv[key].matched = false;
        var val = p_criteria[key];
        // logger.trace(″Criteria″);
        // logger.trace(″criteria key ″, key);
        // logger.trace(″criteria value ″,val);
        // logger.trace(″p_rec[key] = ″, p_rec[key]);
        //logger.trace(″Complex key = ″+key+″
        p_rec[key] = ″,p_rec[key]+″
val=″+val);
        if(p_rec.hasOwnProperty(key))
        {
          if(Array.isArray(val))
          {
            for (var iv in val)
            {
              if(CheckValue(p_rec[key], val[iv], op))
              {
                rv[key].matched = true;
                break;
              }
            }
          }
          else
          {
            if(CheckValue(p_rec[key], val, op))
            {
              rv[key].matched = true;
              // logger.trace(p_rec[key]);
              // logger.trace(key);
            }
          }
        }
      }
      var p_criteria = arrCriteria[i].Criteria;
      var r = true;
      for(var key in p_criteria)
      {
        r = r && rv[key].matched;
        //logger.trace(″complex key=″+key+″
        matched=″+rv[key].matched+″ r=″+r);
      }
      rvLogical.push(r);
    }
    for(var i in arrCriteria)
    {
      if(i == 0)
        returnValue = rvLogical[i];
      else
      {
        switch(opLogical)
        {
          case ″&&″:
            //logger.trace(″rvLogical[″+i+″]=″+rvLogical[i]);
            returnValue = returnValue && rvLogical[i];
            break;
          case ″||″:
            returnValue = returnValue || rvLogical[i];
          default:
            //logger.trace(″unknown Logical operator assuming &&″);
            returnValue = returnValue && rvLogical[i];
            break;
        }
      }
    }
    //logger.trace(″complex returnValue=″+returnValue);
    return returnValue;
  }
```

As alluded to briefly, the classification engine may also be configured to handle complex logical expressions within a query, such as AND, OR, NOR, XOR, etc. logic, either written expressly in this type of language, or in long hand, such as “provide all discussions about animals, except for lions, tigers and bears.” Logical expressions can also include if/then statements, and other conditional language. For example, a query might include “all political communications if the author tweets from California, but if from Montana, then tweets about the keystone pipeline.” The classification criteria can be even longer than mere single sentences. In some embodiments, it may be useful to think of the classification criteria as being analogous to a program or computer code, while the expression evaluator 240 acts as the compiler for interpreting the criteria and matching the words in the criteria to known categories already trained by the classification engine, such as those found in a configuration file.

At block 245, the auction engine determines whether the search criteria matches, or in other words, fits within a category that is already pre-trained by the classification engine. If not, the process resets. However, if a match is found, then that subscriber is notified at block 250 that their query will be processed.

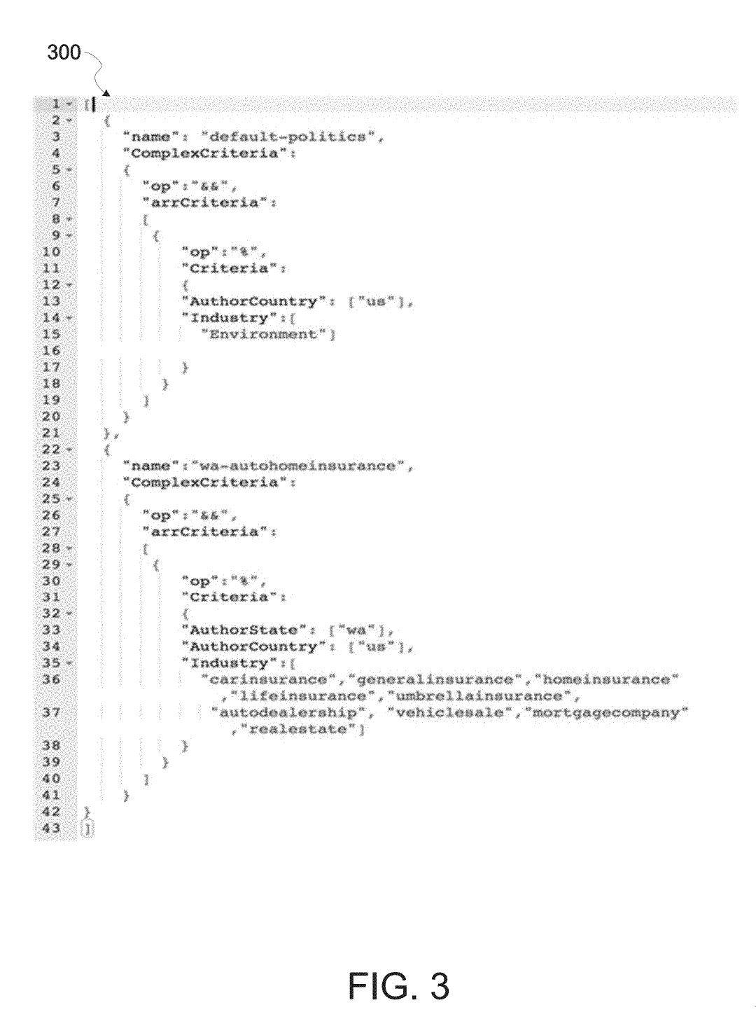

Referring to FIG. 3, illustration 300 shows an example subscription configuration file that may be accessed by the classification engine, according to some embodiments. This configuration file may have been generated by the classification engine during an initial training phase. For example, a small set of documents may be annotated and used to calibrate the engine to understand one or more taxonomies. Feedback may be provided to the engine and machine learning may be employed to develop the correct answers for how documents may be classified. An example taxonomy may be developed in a format similar to the following:

```
{
  ″name″: ″default-insurance″,
  ″ComplexCriteria″: {
    ″op″: ″&&″,
    ″arrCriteria″: [
      {
        ″op″: ″%″,
        ″Criteria″: {
          ″AuthorState″: [
            ″wa″
          ],
          ″AuthorCountry″: [
            ″us″
          ],
          ″SourceIndex″ : [
            ″tacoma″
          ]
        }
      }
    ]
  }
},
```

Once this process is complete, a configuration file like the example shown in illustration 300 may be created.

From this, it can be seen that the specified criteria by a subscriber may be identified by name. Specific words are used in the configuration file, and the classification engine may be capable of associating a large variety of different words specified by the subscriber, that may not exactly match these words in the configuration file, to the words in the configuration file that best match. Also, as previously mentioned, the criteria specified by a subscriber can include multiple topics or subject matter in a single query. One or more configuration files may be accessed by the classification engine to find all the relevant topics specified by the subscriber.

In some embodiments, each criteria topic or subject in the configuration file can be described by an operation and operands. For example, the format shown is {name, value} as a pair for each criterion being considered.

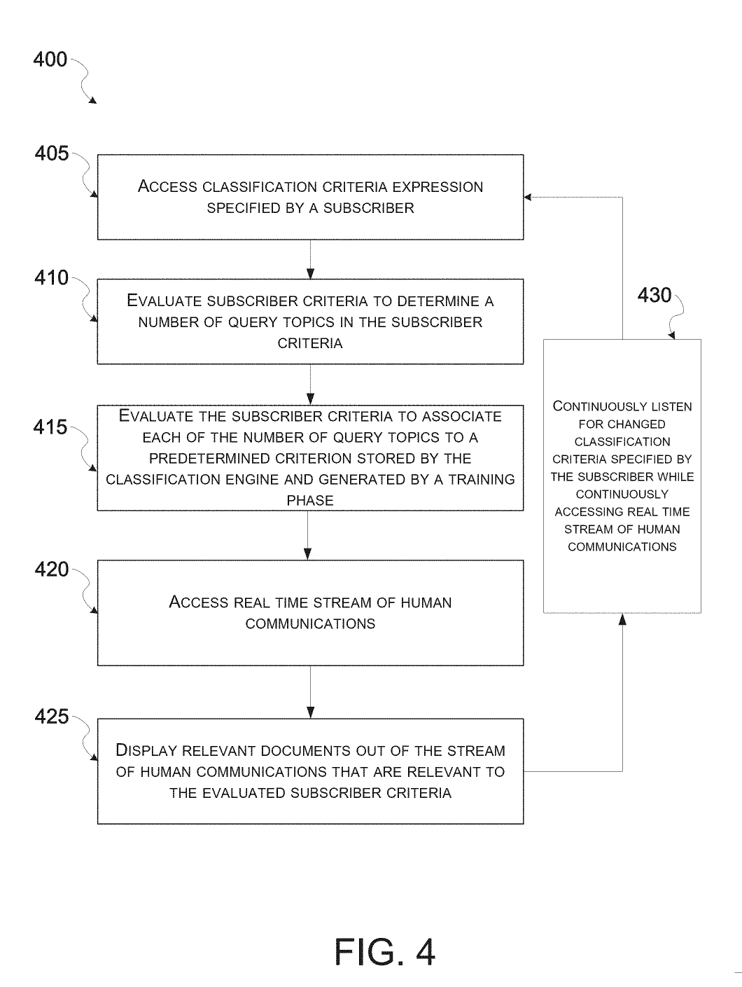

Referring to FIG. 4, flowchart 400 provides an example methodology of a classification engine of the present disclosure for processing classification queries in real time or near real time, as well as processing new classification queries while live streaming human communications, and providing the results to a subscriber, according to some embodiments. As described previously, the classification engine configured to perform this methodology may be capable of evaluating classification criteria worded in various different ways, particularly even when the words used by the subscriber do not exactly match terms that the engine trained on to make a configuration file or other reference source. The example methodology described herein may be consistent with the descriptions in FIGS. 1-3.

At block 405, the classification engine may be configured to access a classification criteria expression from a subscriber (user of the system). The classification criteria expression may represent one or more types of topics that the subscriber intends for the classification to find and classify among a streaming body of human communications. The criteria can be worded in many different ways, even using words and expressions that the classification engine did not use when training for terms or topics of an equivalent meaning. The criteria can include multiple topics, conditional language, logical expressions, and the like. In other words, the subscriber need not know what are the exact topics or words that the classification engine trained on beforehand. The classification engine is flexible to allow varying amounts of the specified content to be in the classification criteria. The subscriber may simply enter whatever classification criteria are desired.

The classification engine may pick up the expression via a listener module or other interface. At block 410, the classification engine may be configured to evaluate the criteria from the subscriber to determine how many query topics the subscriber specified. At block 415, the classification engine may then be configured to evaluate the subscriber criteria to associate each of the number of query topics to a predetermined criterion stored by the classification engine and generated by a training phase. In other words, the engine may evaluate the criteria, worded in an arbitrary manner, and fit the discrete criteria into one or more exact words or phrases that were in fact trained on.

For example, referring back to FIG. 3, a subscriber may have entered “house insurance” as criteria for the classification engine to find among a streaming body of human communications. The engine may first determine that the number of discrete topics for classification is 1. Next, this single phrase is to be associated with at least one exact topic that the classification engine trained on. In examining the configuration file of illustration 300, which represents a distilled set of words and phrases that the classification engine did in fact train on, while that exact phrase does not appear as a topic, the classification engine may utilize natural language processing, machine learning, and/or UHRS techniques to associate “house insurance” with “home insurance,” which is one of the exact trained phrases of the configuration file. In some embodiments, the engine may also associate “house insurance” with “general insurance,” and “umbrella insurance.” In some embodiments, the engine may also associate “house insurance” further with “mortgage company” and “real estate.”

At block 420, after performing any checks to ensure that the criteria match at least one of the trained topics, the classification engine may then be configured to access a real time stream of human communications. For example, the classification engine may ingest the constant flow of all tweets from Twitter® originating from the United States. The classification engine may therefore be receiving millions of tweets a day, and the classification engine may be configured to evaluate each one to see which tweets match the criteria specified by the subscriber.

At block 425, the classification engine may then display each document that it finds out of the stream of human communications that is relevant to the evaluated subscriber criteria. As an example, the classification engine may post to a message board of the subscriber all tweets by people asking about what home insurance their friends or followers are using. If the subscriber criteria includes multiple topics, the classification engine may simultaneously look for all tweets relevant to those other topics, and display those as well.

In some embodiments, the classification engine may also dynamically process changing subscriber criteria. At block 430, the process described herein can repeat, due to the fact that the classification engine may continuously listen for any changed classification criteria specified by the subscriber, while still continuously accessing (ingesting) the real time stream of human communications. Thus, simply on a change of command, the classification engine may evaluate new criteria by repeating the steps in blocks 405-425 for the new classification criteria entered by the subscriber. No additional training may be needed, and the classification engine may now stop providing results for the original criteria, and may change to identify and classify the streaming human communications for the new criteria.

Referring to FIG. 5, the block diagram illustrates components of a machine 500, according to some example embodiments, able to read instructions 524 from a machine-readable medium 522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 5 shows the machine 500 in the example form of a computer system (e.g., a computer) within which the instructions 524 (e.g., software, a program, an application, an applet, an app, or other executable code) for causing the machine 500 to perform any one or more of the methodologies discussed herein may be executed, in whole or in part.

In alternative embodiments, the machine 500 operates as a standalone device or may be connected (e.g., networked) to other machines. In a networked deployment, the machine 500 may operate in the capacity of a server machine 110 or a client machine in a server-client network environment, or as a peer machine in a distributed (e.g., peer-to-peer) network environment. The machine 500 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 524, sequentially or otherwise, that specify actions to be taken by that machine. Further, while only a single machine 500 is illustrated, the term “machine” shall also be taken to include any collection of machines that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a video display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor control device 514 (e.g., a mouse, a touchpad, a trackball, a joystick, a motion sensor, an eye tracking device, or other pointing instrument), a storage unit 516, a signal generation device 518 (e.g., a sound card, an amplifier, a speaker, a headphone jack, or any suitable combination thereof), and a network interface device 520.

The storage unit 516 includes the machine-readable medium 522 (e.g., a tangible and non-transitory machine-readable storage medium) on which are stored the instructions 524 embodying any one or more of the methodologies or functions described herein, including, for example, any of the descriptions of FIGS. 1-4. The instructions 524 may also reside, completely or at least partially, within the main memory 504, within the processor 502 (e.g., within the processor's cache memory), or both, before or during execution thereof by the machine 500. The instructions 524 may also reside in the static memory 506.

Accordingly, the main memory 504 and the processor 502 may be considered machine-readable media 522 (e.g., tangible and non-transitory machine-readable media). The instructions 524 may be transmitted or received over a network 526 via the network interface device 520. For example, the network interface device 520 may communicate the instructions 524 using any one or more transfer protocols (e.g., HTTP). The machine 500 may also represent example means for performing any of the functions described herein, including the processes described in FIGS. 1-4.

In some example embodiments, the machine 500 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 522 able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database 115, or associated caches and servers) able to store instructions 524. The term “machine-readable medium” shall also be taken to include any medium, or combination of multiple media, that is capable of storing the instructions 524 for execution by the machine 500, such that the instructions 524, when executed by one or more processors of the machine 500 (e.g., processor 502), cause the machine 500 to perform any one or more of the methodologies described herein, in whole or in part. Accordingly, a “machine-readable medium” refers to a single storage apparatus or device 120 or 130, as well as cloud-based storage systems or storage networks that include multiple storage apparatus or devices 120 or 130. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 522 is non-transitory in that it does not embody a propagating signal. However, labeling the tangible machine-readable medium 522 as “non-transitory” should not be construed to mean that the medium is incapable of movement; the medium should be considered as being transportable from one physical location to another. Additionally, since the machine-readable medium 522 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 522 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 502 or a group of processors 502) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 502 or other programmable processor 502. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 508) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 502 that are temporarily configured (e.g., by software) or permanently configured to perform the relevant operations. Whether temporarily or permanently configured, such processors 502 may constitute processor-implemented modules that operate to perform one or more operations or functions described herein. As used herein, “processor-implemented module” refers to a hardware module implemented using one or more processors 502.

Similarly, the methods described herein may be at least partially processor-implemented, a processor 502 being an example of hardware. For example, at least some of the operations of a method may be performed by one or more processors 502 or processor-implemented modules. As used herein, “processor-implemented module” refers to a hardware module in which the hardware includes one or more processors 502. Moreover, the one or more processors 502 may also operate to support performance of the relevant operations in a “cloud computing” environment or as a “software as a service” (SaaS). For example, at least some of the operations may be performed by a group of computers (as examples of machines 500 including processors 502), with these operations being accessible via a network 526 (e.g., the Internet) and via one or more appropriate interfaces (e.g., an API).

The performance of certain operations may be distributed among the one or more processors 502, not only residing within a single machine 500, but deployed across a number of machines 500. In some example embodiments, the one or more processors 502 or processor-implemented modules may be located in a single geographic location (e.g., within a home environment, an office environment, or a server farm). In other example embodiments, the one or more processors 502 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 500 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method of a classification engine for classifying a stream of human communications in real time, the method comprising:
accessing, by the classification engine, a classification criteria expression specified by a subscriber of the classification engine, the classification criteria expression comprising a description of one or more topics for the classification engine to search for and classify among the stream of human communications;
evaluating, using artificial intelligence techniques by the classification engine, the classification criteria expression to determine a number of topics specified in the classification criteria expression to be classified in the stream of human communications;
evaluating, using artificial intelligence techniques by the classification engine, the classification criteria expression to associate each of the topics to a predetermined classification criterion that is stored in a memory and generated by a training phase performed by the classification engine, wherein each of the topics as expressed in the classification criteria expression do not exactly match wording in the predetermined classification criterion to which each of the topics are associated to;
accessing, by the classification engine, the stream of human communications in real time;
conducting, by the classification engine, a classification function to identify documents in the stream of human communications that are relevant to at least one of each of the predetermined classification criteria associated to each of the topics in the classification criteria expression; and
displaying, by the classification engine, the relevant documents out of the stream of human communications.

2. The method of claim 1, further comprising accessing, by the classification engine, an additional classification criteria expression specified by the subscriber while still accessing the stream of human communications in real time and conducting the classification function.

3. The method of claim 2, further comprising evaluating the additional classification criteria expression to determine a number of topics in the additional classification criteria to be classified in the stream of human communications, while still accessing the stream of human communications in real time and conducting the classification function.

4. The method of claim 3, further comprising evaluating the additional classification criteria expression to associate each of the additional topics to the predetermined classification criterion that is stored in the memory and generated by the training phase performed by the classification engine, wherein no additional training phase is performed in order to associate each of the additional topics to the predetermined classification criterion.

5. The method of claim 1, wherein each of the predetermined classification criteria are stored in a configuration file that is generated by the training phase.

6. The method of claim 1, wherein the training phase includes utilizing machine learning and universal human relevance system (UHRS) techniques.

7. The method of claim 1, wherein the classification criteria expression includes logical terms comprising at least one of an “AND” expression, “OR” expression, “NOR” expression, and “XOR” expression.

8. The method of claim 7, wherein the predetermined classification criterion does not include any of the logical terms “AND,” “OR,” “NOR” or “XOR.”

9. A classification system for classifying a stream of human communications in real time, the system comprising:
a classification engine comprising at least one processor and at least one memory, the at least one processor configured to utilize artificial intelligence;
a subscriber portal coupled to the classification engine and configured to interface with a subscriber of the classification system; and
a display module communicatively coupled to the classification engine;
wherein the classification engine is configured to:
access a classification criteria expression specified by the subscriber, through the subscriber portal, the classification criteria expression comprising a description of one or more topics for the classification engine to search for and classify among the stream of human communications;
evaluate, using artificial intelligence techniques by the classification engine, the classification criteria expression to determine a number of topics specified in the classification criteria expression to be classified in the stream of human communications;
evaluate, using artificial intelligence techniques by the classification engine, the classification criteria expression to associate each of the topics to a predetermined classification criterion that is stored in the at least one memory and generated by a training phase performed by the classification engine, wherein each of the topics as expressed in the classification criteria expression do not exactly match wording in the predetermined classification criterion to which each of the topics are associated to;
access the stream of human communications in real time; and
conduct a classification function to identify documents in the stream of human communications that are relevant to at least one of each of the predetermined classification criteria associated to each of the topics in the classification criteria expression;
wherein the display module is configured to display the relevant documents out of the stream of human communications.

10. The system of claim 9, wherein the classification engine is further configured to access an additional classification criteria expression specified by the subscriber while still accessing the stream of human communications in real time and conducting the classification function.

11. The system of claim 10, wherein the classification engine is further configured to evaluate the additional classification criteria expression to determine a number of topics in the additional classification criteria to be classified in the stream of human communications, while still accessing the stream of human communications in real time and conducting the classification function.

12. The system of claim 11, wherein the classification engine is further configured to evaluate the additional classification criteria expression to associate each of the additional topics to the predetermined classification criterion that is stored in the memory and generated by the training phase performed by the classification engine, wherein no additional training phase is performed in order to associate each of the additional topics to the predetermined classification criterion.

13. The system of claim 9, wherein each of the predetermined classification criterion are stored in a configuration file that is generated by the training phase.

14. The system of claim 9, wherein the classification criteria expression includes logical terms comprising at least one of an “AND” expression, “OR” expression, “NOR” expression, and “XOR” expression.

15. The system of claim 14, wherein the predetermined classification criterion does not include any of the logical terms “AND,” “OR,” “NOR” or “XOR.”

16. A classification system for classifying a stream of human communications in real time, the system comprising:
a classification engine comprising at least one processor and at least one memory, the at least one processor configured to utilize artificial intelligence;
a listener module configured to constantly listen for any inputs from a subscriber;
a message queue module configured to order a plurality of inputs originating from one or more subscribers;
a publish service module configured to publish outputs of the classification engine; and
a message broker module configured to distribute a plurality of messages from the plurality of subscribers to the message queue module and the publish service module;
wherein the classification engine is configured to:
access a classification criteria expression specified by the subscriber, through the subscriber portal, the classification criteria expression comprising a description of one or more topics for the classification engine to search for and classify among the stream of human communications;
evaluate, using artificial intelligence techniques by the classification engine, the classification criteria expression to determine a number of topics specified in the classification criteria expression to be classified in the stream of human communications;
evaluate, using artificial intelligence techniques by the classification engine, the classification criteria expression to associate each of the topics to a predetermined classification criterion that is stored in the at least one memory and generated by a training phase performed by the classification engine, wherein each of the topics as expressed in the classification criteria expression do not exactly match wording in the predetermined classification criterion to which each of the topics are associated to;
access the stream of human communications in real time; and
conduct a classification function to identify documents in the stream of human communications that are relevant to at least one of each of the predetermined classification criteria associated to each of the topics in the classification criteria expression.

17. The system of claim 16, wherein the classification engine is further configured to access an additional classification criteria expression specified by the subscriber while still accessing the stream of human communications in real time and conducting the classification function.

18. The system of claim 16, wherein the classification engine is further configured to evaluate the additional classification criteria expression to determine a number of topics in the additional classification criteria to be classified in the stream of human communications, while still accessing the stream of human communications in real time and conducting the classification function.

19. The system of claim 18, wherein the classification engine is further configured to evaluate the additional classification criteria expression to associate each of the additional topics to the predetermined classification criterion that is stored in the memory and generated by the training phase performed by the classification engine, wherein no additional training phase is performed in order to associate each of the additional topics to the predetermined classification criterion.

20. The system of claim 19, wherein each of the predetermined classification criterion are stored in a configuration file that is generated by the training phase.
